(19) United States
(12) Patent Application Publication
(10) Pub. No.: US 2005/0144984 A1
(43) Pub. Date: Jul. 7, 2005

(54) Fabrication method and device for porous optical fiber preform

(76) Inventors: Soon-Jae Kim, Gumi-si (KR); Jeong-Hyun Oh, Buk-gu (KR); Keun-Deok Park, Sasang-gu (KR); Byeong-Sam Kim, Gumi-si (KR); Jung-Je Bang, Pohang-si (KR)

Correspondence Address: CHA & REITER, LLC, 210 ROUTE 4 EAST STE 103, PARAMUS, NJ, 07652, US

(21) Appl. No.: 10/922,388

(22) Filed: Aug. 19, 2004

(30) Foreign Application Priority Data
Jan. 6, 2004 (KR) 2004-498

(51) Int. Cl. C03B 37/018

(52) U.S. Cl. 65/393; 65/421; 65/530

(57) ABSTRACT

Disclosed are fabrication method and device for a porous optical fiber preform. The fabrication method includes the steps of (a) rotating one or more rotating disks in a deposition furnace, wherein a plurality of shoot rods are coupled to the one or more rotating disks and spaced at predetermined intervals along a circumferential direction of the one or more rotating disks; (b) supplying a raw material in a gaseous state into the deposition furnace to deposit the raw material onto the shoot rods; (c) after the formation of a silica shoot by deposition of the raw material on the shoot rods, eliminating the shoot rods from silica shoot; and (d) sintering the silica shoot from which the shoot rods are eliminated.

### CLAIM OF PRIORITY

This application claims priority to an application entitled “FABRICATION METHOD AND DEVICE FOR POROUS OPTICAL FIBER PREFORM,” filed in the Korean Intellectual Property Office on Jan. 6, 2004 and assigned Ser. No. 2004-498, the contents of which are hereby incorporated by reference.

### BACKGROUND OF THE INVENTION

1. Field of the Invention

The present invention relates to an optical fiber preform, and more particularly to a fabrication method and device for a porous optical fiber preform.

2. Description of the Related Art

Prior art fabrication methods for an optical fiber preform include a sol-gel method and vapor deposition methods.

In the sol-gel method, a mold is used to convert a raw material in a sol state into a gel state. Then it is sintered, thereby manufactured as an optical fiber preform. The sol-gel method is achieved at a comparatively low temperature to have a low manufacturing cost. It has an advantage in that a composition rate of sol-gel states is easily adjusted. Thus, it is usefully applied to the fabrication of the optical fiber preform.

The vapor deposition methods include chemical vapor deposition (CVD), modified chemical vapor deposition (MCVD), vapor phase axial deposition (VAD), outside vapor deposition (OVD), etc. Advantageously, the vapor deposition methods enable manufacturing an optical fiber preform with a comparatively high quality, This is due because an optical fiber preform in a solid state is manufactured by a gas phase reaction performed for a long period of time at a high temperature of approximately 1,800° C.

One significant limitation of such conventional fabrication methods is the prevention of loss of an optical signal.

In order to prevent optical signal loss, a porous optical fiber has been developed and applied to an optical communication network. The porous optical fiber is provided with an airline, which is extended in a longitudinal direction of the optical fiber. It also has uniform regularity, arranged therein. This is referred to as a “PCF (Photonic Crystal Fiber)”.

A preform for manufacturing the above porous optical fiber is made by arranging a bundle of first preforms in a capillary tube shape. Then, the extension of the first preforms is repeated by a heat treatment process. The heat treatment process may cause deformation of the airline, thereby causing the optical signal loss.

In the sol-gel method for manufacturing the porous optical fiber preform, an elongated time is taken for gelling a sol and then liberating an obtained gel. Thus, productivity is reduced and damage is caused to a molded body during the formation of the airline.

### SUMMARY OF THE INVENTION

Therefore, the present invention has been made to reduce or overcome the above problems in the art. One object of the present invention to provide fabrication method and device for a porous optical fiber preform using a chemical vapor deposition method. The method includes having the uniform arrangement of an airline on the porous optical fiber preform maintained and the porous optical fiber preform easily manufactured.

In accordance with the principles of the present invention, a fabrication method for a porous optical fiber preform is provided comprising the steps of: (a) rotating one or more rotating disks in a deposition furnace, wherein a plurality of shoot rods are coupled to the one or more rotating disks and spaced at predetermined intervals along a circumferential direction of the one or more rotating disks; (b) supplying a raw material in a gaseous state into the deposition furnace to deposit the raw material onto the shoot rods; (c) after the formation of a silica shoot by deposition eliminating the shoot rods from silica shoot; and (d) sintering the silica shoot from which the shoot rods are eliminated..

In accordance with an other aspect of the present invention, a fabrication device is provided for a porous optical fiber preform comprising: a deposition furnace; one or more rotating disks respectively installed at predetermined locations in the deposition furnace; shoot rods respectively fixed to the one or more rotating disks and spaced at predetermined intervals along a circumferential direction of the one or more rotating disks; and an inlet for putting a raw material in a gaseous state into the deposition furnace.

In accordance with other aspects of the present invention: a heating device surrounding an outer wall of the deposition furnace is provided for heating the deposition furnace so as to prevent a raw material in a gaseous state from being deposited onto an inner wall of the deposition furnace; and/or a cooling device is provided for circulating a refrigerant into the shoot rods; and an inlet for putting a raw material in a gaseous state into the deposition furnace therethrough.

### BRIEF DESCRIPTION OF THE DRAWINGS

The present invention will be more clearly understood from the following detailed description taken in conjunction with the accompanying drawings, in which:

FIG. 1 is a flow chart illustrating a fabrication method for a porous optical fiber preform in accordance with a preferred embodiment of the present invention;

FIG. 2 is a schematic view of a fabrication device for a porous optical fiber preform using the fabrication method shown in FIG. 1; and

FIG. 3 is a plan view illustrating a rotating disk and shoot rods of the fabrication device shown in FIG. 2.

### DETAILED DESCRIPTION OF THE INVENTION

Now, embodiments of the present invention will be described in detail with reference to the annexed drawings. In the drawings, the same or similar elements are denoted by the same reference numerals even though they are depicted in different drawings. For the purposes of clarity and simplicity a detailed description of known functions and configurations incorporated herein will be omitted as it may make the subject matter of the present invention unclear.

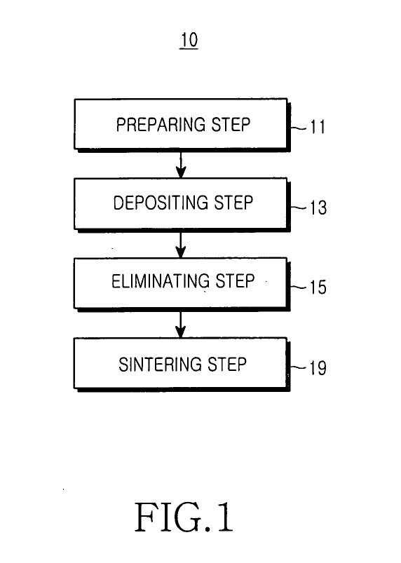

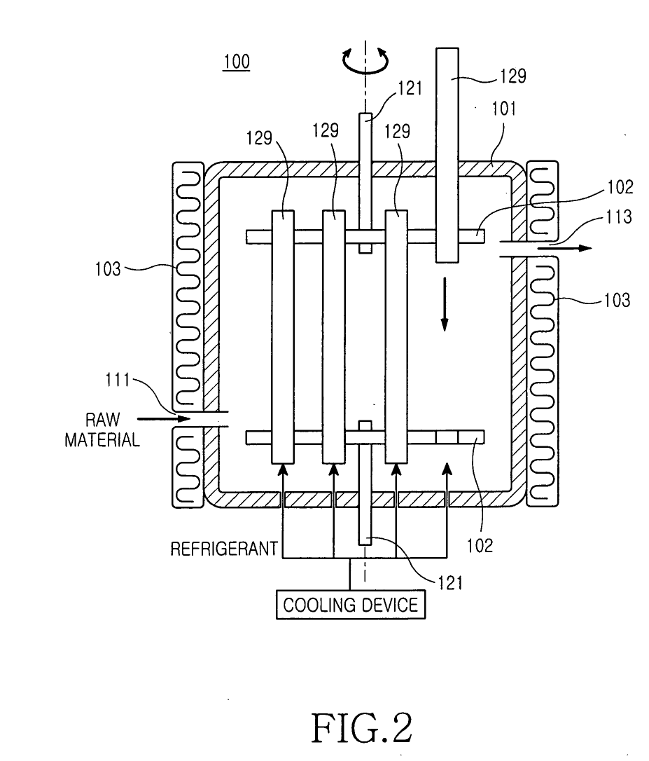

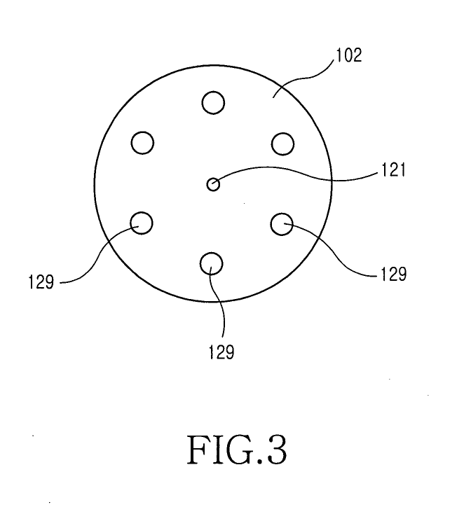

FIG. 1 is a flow chart illustrating a fabrication method 10 for a porous optical fiber preform in accordance with a preferred embodiment of the present invention. FIG. 2 is a schematic view of a fabrication device 100 for a porous optical fiber preform using the fabrication method 10 shown in FIG. 1. FIG. 3 is a plan view illustrating a rotating disk 102 and shoot rods 129 of the fabrication device 100 shown in FIG. 2.

With reference to FIGS. 1 to 3, the fabrication method 10 for a porous optical fiber preform in accordance with the preferred embodiment of the present invention sequentially comprises a preparing step (S11), a depositing step (S13), an eliminating step (S15) and a sintering step (S19). These steps are carried out in the fabrication device 100.

First, the fabrication device 100 for a porous optical fiber preform comprises a deposition furnace 101, the rotating disks 102, and the shoot rods 129.

The deposition furnace 101 is provided with an inlet 111 for receiving a raw material in a gaseous state into the deposition furnace 101. The deposition furnace 101 also includes an outlet 113 for exhausting the undeposited raw material floating in the deposition furnace 101 to the outside.

The rotating disks 102 are rotatably installed at upper and lower portions, respectively, in the deposition furnace 101. They are respectively fixed to rotary shafts 121 rotatably installed at the upper and lower surfaces of the deposition furnace 101. Accordingly, the rotating disks 102 are rotatably installed in the deposition furnace 101.

Both ends of the shoot rods 129 are respectively fixed to the rotating disks 102. The shoot rods 129 are rotated centering on the rotary shafts 121 by the rotation of the rotating disks 102.

The raw material in a gaseous state received by the deposition furnace 101 is deposited onto the shoot rods 129 so that silica shoot (not shown) is obtained. In order to promote the deposition of the raw material onto the shoot rods 129, a predetermined refrigerant is placed into the shoot rods 129. In order to place the refrigerant into the shoot rods 129, the fabrication device 100 further comprises an additional cooling device. The cooling device performs a pumping action so that the refrigerant is uniformly circulated in the shoot rods 129 simultaneously with the introduction of the refrigerant into the shoot rods 129.

Preferably, the rotary shafts 102 are rotated until silica shoot having a proper size are obtained during the deposition of the raw material onto the shoot rods 129. The overall quality of the silica shoot (not shown) is uniformly maintained by uniformly depositing the raw material onto the shoot rods 129.

In order to prevent the raw material received by the deposition furnace 101 from being deposited onto the inner wall of the deposition furnace 101, a heating device 103 surrounding the outer circumference of the deposition furnace 101 is installed. The heating device 103 heats the deposition furnace 101 during the deposition of the raw material. This prevents the raw material from being deposited onto the inner wall of the deposition furnace 101. The cooling device cools the shoot rods 129. Consequently, the raw material is deposited onto the shoot rods 129.

Hereinafter, the fabrication method 10 for a porous optical fiber preform using the above-described fabrication device 100 will be described. The fabrication method 10 using the fabrication device 100 comprises the preparing step (S11), the depositing step (S13), the eliminating step (S15), and the sintering step (S19).

In the preparing step (S11), both ends of the shoot rods 129 are fixed to the rotating disks 102. As shown in FIG. 3, the shoot rods 129 are installed on each of the rotating disks 102 at regular intervals along the circumferential direction of the rotating disks 102. Also, they are symmetrically centered on the rotary shaft 121. With reference to FIG. 3, the shoot rods 129 are arranged in such a manner that they are installed at regular intervals along the circumferential direction of the rotating disk 102. However, the shoot rods 129 may be arranged so that they are installed along the radial direction of the rotating disk 102 and are symmetrically centered on the rotary shaft 121. Further, the shoot rods 129 shown in FIG. 3 have a uniform diameter. However, when the shoot rods 129 are arranged along the radial direction of the rotating disk 102, the shoot rod 129 close to the rotary shaft 121 may have a smaller diameter than the other shoot rods 129. Further, although the shoot rods 129 shown in FIG. 3 have a circular cross-section, the shoot rods 129 may have various shaped cross-sections such as a polygonal cross-section. Those skilled in the art will appreciated that various modifications of the arrangement or diameter of the shoot rods 129 are possible according to the requirements of the optical fiber to be manufactured.

In the depositing step (S13), the raw material in a gaseous state is received by the deposition furnace 101. It is deposited onto the shoot rods 129 installed on each of the rotating disks 102, thereby forming silica shoot (not shown). In order to uniformly deposit the raw material onto the shoot rods 129, the rotating disks 102 are rotated centering on the rotary shafts 121 during the deposition of the raw material. Further, it is desirable to promote the deposition of the raw material onto the shoot rods 129 and prevent the raw material from being deposited onto the inner wall of the deposition furnace 101. To this end, the cooling device and the heating device 103 may be operated simultaneously during the depositing step (S113).

In the eliminating step (S15), after the formation of the silica shoots by the deposition of the raw material onto the shoot rods 129, the shoot rods 129 are eliminated from the silica shoot. Thus, when an optical fiber is drawn from a manufactured optical fiber preform, the optical fiber is embodied as a porous optical fiber provided with an airline at an area where the shoot rod 129 is eliminated from the silica shoot.

In the sintering step (S19), the silica shoot, from which the shoot rods 129 are eliminated, is sintered to remove impurities and obtain hard sintered bodies. In the sintering step (S19), the heating device 103 positioned in the deposition furnace 101 is used.

The above fabrication method 10 for a porous optical fiber preform is carried out in a single deposition furnace to simplify the fabrication process. In addition, the shoot rods are rotated during the deposition so that uniform deposition is induced.

As apparent from the above description, the present invention provides a fabrication method and device for a porous optical fiber preform, in which the overall fabrication process from the deposition of a raw material to the formation of sintered bodies by sintering silica shoots is performed in a deposition furnace. Thus, the fabrication process is simplified. Further, the shoot rods are rotated centering on a rotary shaft during the deposition of the raw material onto the shoot rods, thereby forming (1) a uniform airline on the preform, (2) shortening time taken to manufacture the porous optical fiber perform, and (3) increasing the manufactured amount of the preform.

Although preferred embodiments of the present invention have been disclosed for illustrative purposes, those skilled in the art will appreciate that various modifications, additions, and substitutions to the specific elements are possible, without departing from the scope and spirit of the invention as disclosed in the accompanying claims.

1. A fabrication method for a porous optical fiber preform comprising the steps of:
(a) rotating one or more rotating disks in a deposition furnace, wherein a plurality of shoot rods are coupled to the one or more rotating disks and spaced at predetermined intervals along a circumferential direction of the one or more rotating disks;
(b) supplying a raw material in a gaseous state into the deposition furnace to deposit the raw material onto the shoot rods;
(c) after the formation of a silica shoot by deposition of the raw material on the shoot rods, eliminating the shoot rods from the silica shoot; and
(d) sintering the silica shoot from which the shoot rods are eliminated.

2. The fabrication method as set forth in claim 1, wherein the deposition furnace is provided with the rotating disks at upper and lower portions thereof and respective ends of the plurality of shoot rods are fixed to the rotation disks and the shoot rods are spaced at regular intervals along a circumferential direction of the rotating disks.

3. The fabrication method as set forth in claim 1, wherein in steps (a) and (b) the deposition furnace is heated from the outside so as to prevent the raw material in the gaseous state from being deposited onto an inner wall of the deposition furnace.

4. The fabrication method as set forth in claim 1, wherein in steps (a) and (b) a refrigerant is circulated into the shoot rods so as to promote the deposition of the raw material in the gaseous state onto the shoot rods.

5. A fabrication device for a porous optical fiber preform comprising:
a deposition furnace;
one or more rotating disks respectively installed at predetermined locations in the deposition furnace;
shoot rods respectively fixed to the one or more rotating disks and spaced at predetermined intervals along a circumferential direction of the one or more rotating disks; and
an inlet for putting a raw material in a gaseous state into the deposition furnace.

6. The fabrication device as set forth in claim 5, further comprising a heating device surrounding an outer wall of the deposition furnace for heating the deposition furnace so as to prevent the raw material in the gaseous state from being deposited onto an inner wall of the deposition furnace.

7. The fabrication device as set forth in claim 5, further comprising a cooling device for circulating a refrigerant into the shoot rods so as to promote the deposition of the raw material onto the shoot rods.

8. The fabrication device as set forth in claim 4, further comprising an outlet for exhausting the undeposited raw material floating in the deposition furnace to the outside.

9. A fabrication device for a porous optical fiber preform comprising:
a deposition furnace;
rotating disks respectively installed at upper and lower portions in the deposition furnace;
shoot rods provided with both ends respectively fixed to the rotating disks and spaced at regular intervals along a circumferential direction of the rotating disks;
a heating device surrounding an outer wall of the deposition furnace for heating the deposition furnace so as to prevent a raw material in a gaseous state from being deposited onto an inner wall of the deposition furnace; and
an inlet for putting the raw material in the gaseous state into the deposition furnace therethrough.

10. The fabrication device as set forth in claim 9, further comprising a cooling device for circulating a refrigerant into the shoot rods.
